(19) United States
(12) Patent Application Publication
(10) Pub. No.: US 2007/0136752 A1
(43) Pub. Date: Jun. 14, 2007

(54) Personalized electronic programming guide

(76) Inventor: John Sanders, Ramona, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/299,465

(22) Filed: Dec. 12, 2005

(51) Int. Cl. H04N 5/445; G10L 11/00; G06F 13/00; G10L 21/00

(52) U.S. Cl. 725/46; 725/45; 704/275

(57) ABSTRACT

At least one computer-readable medium encoded with instructions is provided, which, when executed by a processor, performs a method including the steps of: identifying a viewer registered with a set top terminal; retrieving from a database at least one viewer preference associated with the registered viewer, the viewer preference reflecting a programming preference of the viewer; selecting from among a plurality of programs listed in an EPG at least one program in accordance with the viewer preference; and presenting to the registered viewer at least a portion of information pertaining to the program that is included in the EPG.

### FIELD OF THE INVENTION

The present invention relates generally to electronic programming guides (EPGs) employed by set top terminals, and more particularly to an EPG that is personalized for each registered viewer so that it can present programming recommendations that reflect the registered viewer's personal programming preferences.

### BACKGROUND OF THE INVENTION

A conventional system for displaying a program, e.g., a video program, includes a monitor or a television (TV) set connected to a set top box or terminal. The set top box is connected through a coaxial cable to a cable TV network or a satellite dish for “satellite TV.” The TV set and the set top box are located, for example, in a user's home and receive a multitude of TV channels from a broadcast head end, wherein each TV channel has a multitude of programs during a typical day. In order to select and watch a certain program, the user controls the set top box to tune to a desired channel. The TV set receives a video signal from the set top box and displays the program of the desired channel.

Set top terminals often enhance a television viewer's experience by employing one or more Electronic Program Guides (EPGs). As known in the art, the electronic program guide lists scheduled programs for a predetermined period of time (e.g., two weeks) and provides, among others, information about broadcast dates and times and content information. For example, the program attributes may include the content information, which describes for each program the channel, actor, director, title, genre, language and the like. With an EPG, television viewers navigate through an onscreen program guide to locate programming. Typically viewers browse the guide or query it. With a guide, viewers browse currently available programming and schedules of programming available in the future. By using keywords or categories, viewers typically search the guide for programming. With an EPG, the viewers may also set reminders for upcoming programs or enter instructions to record one or more shows.

Although set-top terminals equipped with an EPG enable users to identify and locate programming of interest to them, it has become more and more difficult and time-consuming to use as the number of channels and diversity of available programming continues to increase. Accordingly, it would be helpful if EPGs could meet these increasing needs in a more intelligent way. For instance, it would be helpful if the EPG could be arranged so that the viewer does not need to search the entire EPG to find programming of interest. More specifically, it would be helpful if the EPG could be tailored to individual preferences of each viewer so that the viewer can be presented with a selection of recommended programs that best conform to the viewer's preferences.

### BRIEF DESCRIPTION OF THE DRAWINGS

FIG. 1 shows a functional block diagram of a digital set-top terminal.

FIG. 2 illustrates one example of a viewer profile table containing viewer programming preferences.

FIG. 3 shows an illustrative main menu that may be presented to the viewer upon initiation of a voice activation mode of operation.

FIGS. 4-5 show additional menus that may be presented for registered viewers.

FIG. 6 is a flowchart illustrating an example of how a viewer may register with the set top terminal to obtain personalized programming recommendations.

### DETAILED DESCRIPTION

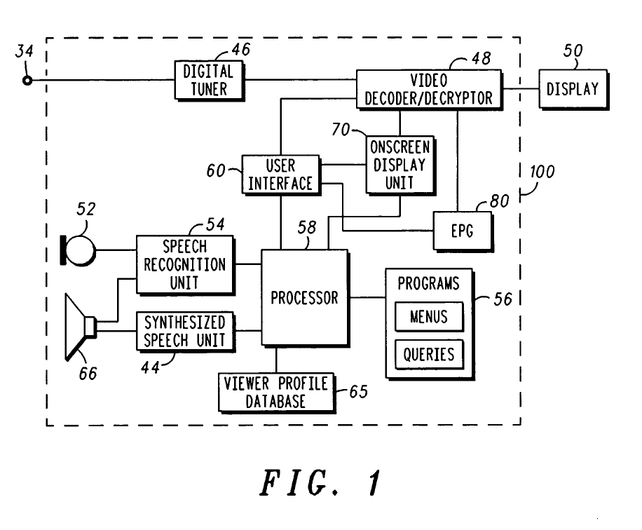

FIG. 1 shows a digital set-top terminal 100. These units offer digital video, audio, and high speed-data services along with streaming media, PPV, Internet services, HDTV, and personal video recorder (PVR) capabilities. Of course, digital set top 100 terminal is only one example of set top terminal and is presented by way of illustration only.

Digital set-top terminal 100 includes a digital tuner 46 for tuning to a desired digital television channel from the band of television signals received by the set-top 100 via input 34. Decryption and decompression hardware and associated software are included in the video decoder/decrypter 48 or decoding the tuned digital signal (e.g. an MPEG-2 television signal) prior to sending it to the display 50. The decoder/decrypter 48 may also include decryption circuitry that decrypts an encrypted content from the content feed. Some broadcasts, particularly pay-per-view broadcasts or premium channels such as HBO™ and Showtime™ are encrypted so that non-subscribers cannot view the content. The decrypter 48 decrypts any such encrypted content for viewing on the display unit 50 by the consumer. The decrypter may include a variety of decryption schemes for corresponding premium channels or services. As with conventional cable boxes, the decryption circuitry may be enabled or disabled depending upon the consumer's subscription to the premium channel or associated encrypted content. Authorization for decryption may be governed by appropriate payment for the associated content. For example, pay-per-view content is typically encrypted with decryption authorization governed by an appropriate payment by the consumer.

While not shown in FIG. 1, it will be recognized that the digital set-top terminal 100 will generally also include an analog tuner to decode and display analog video.

An electronic program guide (EPG) 80 is also provided in set-top terminal 100. The EPG 80 is an interactive, on-screen display feature that displays information analogous to TV listings found in local newspapers or other print media. An EPG provides information about each program being broadcast within the time period covered by the EPG, which typically ranges from the next hour up to several days. The information contained in an EPG includes programming characteristics such as, for example, channel number, program title, start time, end time, elapsed time, time remaining, a brief description of the program's content and possibly the names of individuals associated with the program such as the actors, writers and director. The EPG, which is generally received along with the programming content, may be updated on a periodic basis so that the consumer can make appropriate selection for upcoming programs. The electronic program guide 80 displays information on the display unit 50 using onscreen display processor 70, which is also used for displaying additional information such as control menus and the like. For example, the electronic program guide 80 may display programs in a tabular format by channel and time so that the user can make selections of desired content. In some cases, instead of transmitting it along with the programming, the electronic program guide 80 may be downloaded via a telephone line, cable connection, satellite up-link, or radio broadcast antenna.

The digital set-top terminal 100 also includes a user interface 60. The user interface 60 may include various control devices such as a keypad connected directly to the set top box 100 or a remote control device connected by an Infrared link. The user interface 60 permits the user to interact with the set top box 100 and electronic program guide 80 to thereby select content for recording and on-demand playback. Also, as detailed below, user interface 60 may be employed to create individual viewer profiles that can be used to select personalized program recommendations from among those available in the EPG 80. The recommendations can then be presented to the viewer so that he or she does not need to refer to the complete EPG 80 to select a program to watch.

As an adjunct to the user interface 60, some set top terminals may also receive user commands and other instructions by voice input. In such a case the set top terminal 100 also includes a microphone 52 that is operative to detect a speech signal. Microphone 52 converts the speech signal to an electric signal as is well known in the art. The electric signal is provided to a speech recognition unit 54, also referred to as a voice recognition unit. Hereinafter, the terms “speech recognition” and “voice recognition” are interchangeably used.

Speech recognition unit 54 may be either a speaker dependent speech recognition unit or a speaker independent speech recognition unit. A description of such conventional voice recognition units, which are well known in the art, may be found in many publications, such as in the reference entitled “Automatic Speech Recognition, The Development of the SPHINX System”, by Kai-Fu Lee, Kluwer Academic Publishers, and in the reference entitled “Digital Speech Processing, Synthesis, and Recognition”, by Sadaoki Fururi, Marcel Dekker, Inc. Publishing, in Chapter 8. Generally, in a speaker dependent speech recognition configuration a speaker is identified, and only words or phrases which are spoken by the identified speaker are recognized. In a speaker independent speech recognition configuration specific words are recognized, regardless of the person who speaks them.

Speech recognition unit 54 may include conventional interface circuitry for operating a speaker 66, which may be employed to provide voice messages to the user. The voice messages may be accompanied by messages displayed on display unit 50. In some cases the set top terminal 100 may not include its own dedicated speaker, but may simply employ the speaker associated with the display unit 50.

Input parameters and other information needed for operation of speech recognition unit 54 may be provided to speech recognition unit 54 via user interface 60. The user interface 60 typically receives the input parameters from a remote control via an infrared or an RF link, or from a keyboard, which may be a conventional keyboard that typically forms part of a conventional set top terminal. The input parameters may be received in response to requests that are presented to the subscriber on display unit 50.

The aforementioned components of set-top terminal 100 may all operate under the control of a processor 58. Moreover, it is contemplated that the processor 58, digital tuner 46, video decoder 48, user interface processor 60, onscreen display processor 70, speech recognition unit 54 and the other components shown in FIG. 1 may each be implemented in hardware, software or a combination thereof. In addition, although the various components are shown as separate processors, it is contemplated that they may be combined and implemented as separate processes on one or more processors.

The on-screen display unit 70, under the control of the EPG 80, the processor 58, the user interface 60, or the speech recognition unit may generate messages and graphic information which are converted by display unit 70 to a format suitable for display on display unit 50, which may be, for example, a conventional television display. The messages may include menus, error messages, control messages and the viewer profiles discussed below.

The viewer may browse through the program guide, operate features in the program guide, refer to data presented on on-screen menus, retrieve selected program guide data, record programs, make selections and configure the program guide. All these operations may be performed either in a conventional mode of operation by pressing keys on a keyboard or remote control associated with user interface 60, or in a voice activated mode of operation by entering voice commands and instructions and by making voice selections with the use of the speaker 66 and speech recognition unit 54. Additionally, these operations may be done while the viewer is viewing programming on display unit 50.

Current digital broadcasting systems may include two hundred or more channels that are available to viewers. In this regard, it is impractical to scan all the available channels to search for a desired broadcast program. The EPG 80 helps viewers to more quickly and efficiently search for a desired program. However, with so many available channels, even searching through the entire EPG can be arduous. As previously mentioned, it would be helpful if the EPG could be tailored to individual preferences of each viewer so that the viewer can be presented with a selection of recommended programs that best conform to the viewer's preferences. In this way the viewer does not need to search the entire EPG to find programming he or she may be interested in. For instance, one particular viewer may be interested in certain professional sports programming such as baseball and basketball as well as movies belonging to a particular genre (e.g. westerns, classics, science fiction) while another viewer may be interested in topical programming such as documentaries and news. The recommended programs may be presented to the viewer whenever the viewer begins a viewing session (by turning on the set top terminal, for example) or at any time upon request.

Returning to FIG. 1, set top terminal 100 includes a viewer profile database 65 that stores profiles of each registered viewer. The profiles contain an identifier for each registered viewer (such as a first name) and a series of preferences that represent criteria that can be used to select preferred programming content for that viewer. FIG. 2 illustrates one example of a viewer profile table for three viewers, say Dave, Tom and Jennifer. The table is shown in a format that is suitable for display on display unit 50. Processor 58 can extract the viewer table from the viewer profile database 65 and forward it to on-screen display unit 70 for presentation on display unit 50. The various fields of each profile may be populated by the viewer using a keyboard or other input device associated with user interface 60. Alternatively, the various fields may be populated by the viewer using voice commands that are received by the speech recognition unit 54 via microphone 52.

The viewer profile table may be formatted in a wide variety of different configurations and is not limited to the particular configuration shown in FIG. 2. For instance, the viewer may be presented with a series of questions, the answers to which form the basis for developing the viewer profile. The questions may be presented to the viewer on the display unit 50 or may be presented verbally using a synthesized voice processing unit 44 and speaker 66. In either case the viewer may have the option of responding to the questions using voice commands or the keyboard or other input devices associated with user interface 60.

In the table shown in FIG. 2, the series of preferences are selected from pull-down menus 86₁, 86₂, . . . 86ₙ. Each pull-down menu 86 gives the viewer a selection of options from which to choose. For instance, menu 86₁, may ask the viewer to select his or her favorite genre, menu 86₂ may ask the viewer to select his or her favorite channel, and so on. Some menus may even give the viewer an opportunity to exclude any particular programs or types of programming. The viewer is also given the opportunity to enter keywords in a keyword field 88 hat are to be associated with each preference. For instance, if menu 86₁, asks viewers to pick a favorite genre and the viewer selects westerns, the viewer may enter as keywords in field 88₁, “John Wayne” and “John Ford.” In this case the viewer profile will be used by the processor 58 to identify and select any programming that belongs to the western genre that is found in the EPG 80 and which lists John Wayne (presumably as the lead actor) and/or John Ford (presumably as the director). Of course, the viewer profiles may be developed with viewer input using a wide variety of different queries, menus, and other techniques for eliciting viewer input and is not limited to the particular example shown in FIG. 2.

The viewer profiles also may be developed using additional information that is not directly obtained from the viewer, but from observation of the viewer's behavior and habits. For instance, the history or log of programming previously viewed by an individual viewer may be employed to develop the viewer profile. For instance, if the programming history indicates that the viewer tends to predominantly watch one channel or one particular type of programming (e.g., old situation comedies), this information could be automatically treated as the basis for establishing a user preference. This information could be used to supplement, or even replace, the viewer profile information that is obtained directly from the viewer in response to questions, menu selections, and the like.

The viewer profiles stored in database 65 are used to build personalized programming guides by extracting programming information from the EPG 80 in accordance with the viewer profile. Processor 58 is used to develop the viewer profiles using executable programs that include questionnaires, menus and the like, which are stored in program database 56. Processor 58 is also used to extract preferred programming from the EPG 80 using the information stored in viewer profile database 65.

The personalized programming guide that is established by processor 58 may be forwarded to the on-screen display unit 70 by the processor 58 so that it can be presented to the viewer on the display 50 in any appropriate format, including but not limited to the same format in which the entire the EPG 80 is presented. Alternatively, or in addition thereto, the preferred programming may be presented to the viewer verbally using, for example, the synthesized voice processing unit 44 and speaker 66 or an audio stream directly available from the EPG. Depending on the format in which the EPG information is received, synthesized voice processing unit 44 may include a text to speech synthesizer to verbally present the preferred programming. In some cases the speech synthesizer may employ prerecorded prompts that are used or inserted in the verbal presentation.

For each preferred program, regardless of the format in which it is presented, the information may be the same as that displayed in the EPG 80 or an abbreviated portion thereof. If only an abbreviated portion of the available information for a given program is presented, a dynamic link may be provided so that the viewer can obtain more detailed information about the program from the EPG 80 itself.

As mentioned before, set top terminal 100 may operate either in a voice activated mode, or in a conventional mode of operation. Selection of the voice activation mode may be enabled by pressing a voice activation key on the keyboard of user interface 60 or the remote control. Upon enabling speech control, the viewer may provide voice commands by speaking directly to the microphone 52 or to an internal microphone (not shown) in the remote control.

The voice commands received by the microphone 52 are provided to speech recognition unit 54, which processes and compares them to reference messages that may be stored either in a memory that forms part of speech recognition unit 54 or in a separate memory. Speech recognition unit 54 may provide the processed commands to processor 58 in an appropriate signal format recognized by processor 58, which in turn may control various functions in accordance with the voice commands.

If speech recognition unit 54 is a speaker independent unit, any legitimate command which is spoken is executed, regardless of the viewer who speaks it, even if it is spoken on the audio track of the programming that is being played. This can be a particular problem if multiple individuals are viewing the program and are conversing among themselves. That is, in a speaker independent configuration, if one of the viewers speaks one or more of the command and selection words during a conversation, an erroneous selection may be generated since the voice recognition unit will recognize these words regardless of the person who speaks them. This problem can be overcome in a variety of ways. For example, as discussed in U.S. Appl. Ser. No. 2002/0,052,746, erroneous commands and selections are avoided by employing special word combinations and phoneme combinations for voice commands and voice selections. The special word combinations may be generated in accordance with simple logical rules which may be clearly displayed on the display unit 50. For instance, if the viewer is asked to select from a menus of options that are laid out in a two-dimensional grid on the display unit 50, the rows and columns of the grid may be represented by letters and numbers, respectively. In this case the viewer can make a selection by speaking a letter-number combination such as “B3” or “C4.” Commands such as up, down, delete, and the like may also be selected by special word combinations that are displayed on the display unit 50. Preferably, the special word combinations are not normally employed in conversation. That is, the special word combinations used for navigation and execution are simple combinations which are not normally used in a conversation. Thus, a normal conversation would generally not interfere with such voice commands when they include such combinations.

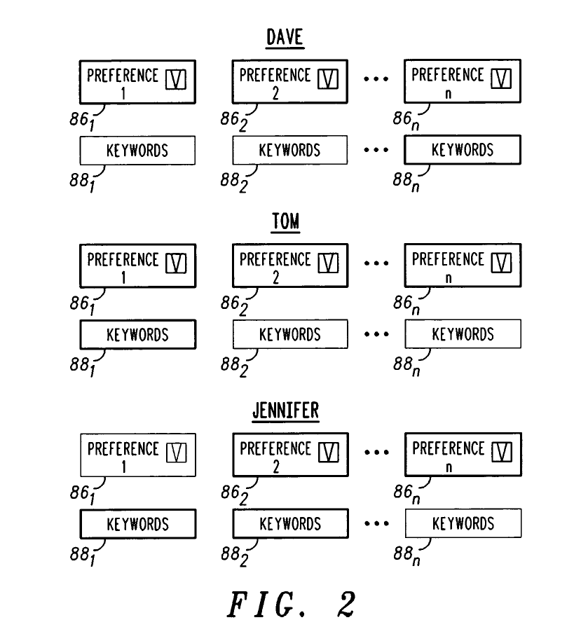

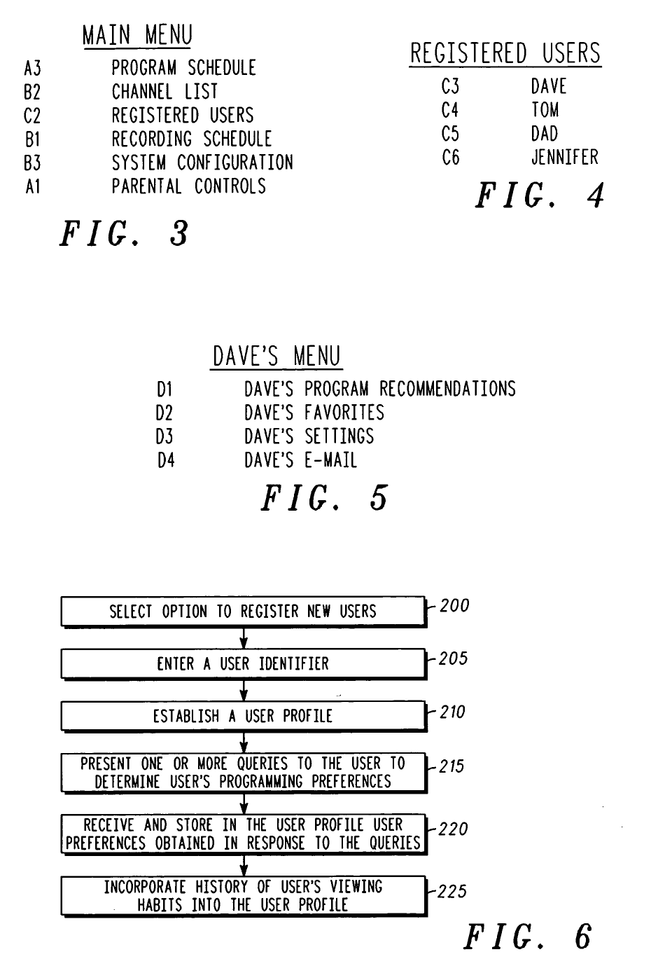

FIG. 3 shows an illustrative main menu that may be presented to the viewer upon initiation of a voice activation mode in which commands and instructions are selected by speaking a letter-number combination. As shown, the menu options may include Program Schedule, Channel List, Registered Viewers, Recording Schedule, System Configuration and Parental Controls. If the viewer chooses “registered viewers,” for instance, by speaking “C2,” a second menu is displayed (FIG. 4) showing each of the registered viewers. Upon choosing a selected name, say Dave, another menu (FIG. 5) is displayed that lists one or more items that pertain to various customized options from which the speaker can speak.

On the other hand, if speech recognition unit 54 is a speaker dependent unit, unit 54 is required to recognize each speaker. This may be done by prior training of unit 54 by each speaker. Techniques for training speech recognition unit 54 are well known and generally include having the viewer repetitively speak words and phrases. The spoken words are analyzed in speech recognition unit 54. The results of such training may form the speech characteristics of each viewer, which are then stored in the internal memory of speech recognition unit 54 or in a separate memory. Typically, the speech characteristics of a viewer may include phonemes and subphonemes, and utterance templates, such as word reference templates, as is well known in the art. The training mode may be entered via the user interface 60.

FIG. 6 is a flowchart illustrating an example of how a user may register with the set top terminal so that he or she can obtain personalized programming recommendations. The process begins in step 200, when the user selects from a menu such as those in FIGS. 3 and 4 an option to register new users. The user may make this selection, as well as enter other selections and provide other user inputs discussed below, using the user interface 60, the speech recognition unit 54, or a combination thereof. In step 205 the user enters a user identifier such as a first name, nickname, or the like. In step 210 a user profile is established for the user and associated with the user identifier. Next, information pertaining to the user's viewing and programming preferences is elicited from the user through various queries that are presented in step 215. The information that is elicited from the user is used to populate the user profile in step 220. If available, in step 225 a history or log of the user's viewing habits are also used to refine, revise and/or supplement the user profile.

The processes described above in connection with the set-top terminal 100 may be implemented in general, multi-purpose or single purpose processors respectively associated with the set-top terminal 100. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. At least one computer-readable medium encoded with instructions which, when executed by a processor, performs a method including the steps of:
identifying a viewer registered with a set top terminal;
retrieving from a database at least one viewer preference associated with the registered viewer, said viewer preference reflecting a programming preference of the viewer;
selecting from among a plurality of programs listed in an EPG at least one program in accordance with the at least one viewer preference; and
presenting to the registered viewer at least a portion of information pertaining to the at least one program that is included in the EPG.

2. The computer-readable medium of claim 1 wherein identifying the registered viewer includes receiving a spoken identifier from the viewer and recognizing the viewer from the spoken identifier using a voice-recognition process.

3. The computer-readable medium of claim 2 wherein the voice-recognition process is a speaker independent voice-recognition process.

4. The computer-readable medium of claim 2 wherein the voice-recognition process is a speaker dependent voice-recognition process.

5. The computer-readable medium of claim 2 wherein the spoken identifier is an alphanumeric code assigned to the viewer by the set top terminal

6. The computer-readable medium of claim 1 wherein the at least one viewer preference associated with the registered viewer is provided directly by the viewer in response to a query.

7. The computer-readable medium of claim 6 wherein the query is presented to the viewer at least in part as a pull-down menu of options on a display device.

8. The computer-readable medium of claim 1 wherein the at least one viewer preference associated with the registered viewer is based at least in part on a history of previous programming selected by the viewer.

9. The computer-readable medium of claim 1 wherein the portion of information pertaining to the at least one program is presented on a display device.

10. The computer-readable medium of claim 1 wherein the portion of information pertaining to the at least one program is verbally presented.

11. The computer-readable medium of claim 1 further comprising the step of presenting to the registered viewer an option to view the at least one program.

12. The computer-readable medium of claim 11 wherein the option to view the at least one program includes the option record the at least one program for later viewing.

13. The computer-readable medium of claim 1 further comprising presenting a personalized menu of viewer options customized to the registered viewer.

14. The computer-readable medium of claim 1 further comprising presenting to the registered viewer a link to obtain additional information located in the EPG pertaining to the at least one program.

15. At least one computer-readable medium encoded with instructions which, when executed by a processor, performs a method including the steps of:
receiving and electronically storing a viewer identifier provided by the viewer;
establishing in an electronic database a viewer profile identifiable and retrievable by the viewer identifier;
obtaining at least one viewer preference from the viewer reflecting a programming preference of the viewer;
associating the at least one viewer preference with the viewer profile and storing the at least one viewer preference in the database to thereby allow at least one program to be selected from an EPG that conforms to the at least one viewer preference.

16. The computer-readable medium of claim 15 further comprising receiving a viewer selection of a program and presenting the selected program to the viewer upon request.

17. The computer-readable medium of claim 15 presenting at least one query to the viewer to obtain a programming preference of the viewer.

18. A set top terminal comprising:
a receiver/tuner for receiving programming content over a broadband communications network;
a decoder for decoding the programming content provided by the receiver/tuner;
a first database for storing an EPG;
a second database capable of storing a plurality of viewer profiles each containing at least one viewer preference associated with a registered viewer, said viewer preference reflecting a programming preference of the viewer;
a user interface operationally associated with the processor;
a processor operationally associated with the receiver/tuner, the decoder, the first and second databases, and the user interface;
wherein the processor is configured to:
identify a viewer as a registered viewer;
retrieve from the second database the viewer profile of the registered viewer;
select from among a plurality of programs listed in the EPG at least one program in accordance with the at least one viewer preference; and
present to the registered viewer at least a portion of information pertaining to the at least one program that is included in the EPG.

19. The set top terminal of claim 18 further comprising an on-screen display unit for displaying the portion of information on a display.

20. The set top terminal of claim 18 further comprising a voice synthesizer unit for presenting the portion of information to the viewer.

21. The set top terminal of claim 18 wherein the user interface comprises a keypad.

22. The set top terminal of claim 18 wherein the user interface comprises a voice-recognition unit.
